(19) United States
(12) Patent Application Publication
(10) Pub. No.: US 2026/0238906 A1
(43) Pub. Date: Aug. 13, 2026

(54) OPTICAL LINE TERMINAL USING NETWORK PROCESSING UNIT TO PERFORM DYNAMIC BANDWIDTH ALLOCATION AND RELATED DYNAMIC BANDWIDTH ALLOCATION METHOD

(71) Applicant: Airoha Technology (Suzhou) Limited, Suzhou City (CN)

(72) Inventors: JUN PAN, Nanjing City (CN); WEIFENG XU, Nanjing City (CN)

(73) Assignee: Airoha Technology (Suzhou) Limited, Suzhou City (CN)

(21) Appl. No.: 19/218,656

(22) Filed: May 27, 2025

(30) Foreign Application Priority Data
Feb. 11, 2025 (CN) 202510150124.6

(51) Int. Cl. H04Q 11/00

(52) U.S. Cl. CPC H04Q 11/0067; H04Q 2011/0064; H04Q 2011/0086

(57) ABSTRACT

An optical line terminal (OLT) includes a central processing unit (CPU) and a network processing unit (NPU). The NPU is used for performing dynamic bandwidth allocation (DBA), where the DBA refers to frame contents transmitted by at least one transmission container within an upstream frame to determine bandwidth allocated to the at least one transmission container.

### BACKGROUND OF THE INVENTION

### 1. Field of the Invention

The present invention relates to a dynamic bandwidth allocation (DBA) technique, and more particularly, to an optical line terminal that uses a network processing unit to perform DBA and a related DBA method.

### 2. Description of the Prior Art

Gigabit Passive Optical Network (GPON) is the latest generation of broadband passive optical network standards that are based on the ITU-TG.984.x standards. It has many advantages such as high bandwidth, high efficiency, large coverage, and low operating cost. The downstream direction (e.g., from an optical line terminal (OLT) to an optical network unit (ONU)) uses broadcasting, while the upstream direction (e.g., from an ONU to an OLT) uses time division multiple access (TDMA) to allocate the bandwidth. Each ONU shares the same optical distribution network (ODN). To ensure that data does not overlap or conflict, there may be at most one transmission container (tcont) allowed to access the shared ODN at any time in the upstream direction. Hence, the OLT uses two fields, including a start_time field and a stop_time field, to indicate the start time and the end time of data transmission for each transmission container, and settings of start_time and stop_time are determined based on the bandwidth allocated to the transmission container.

Since a central processing unit (CPU) of the OLT has more computing power, the traditional approach is to use the CPU to perform DBA. However, when the CPU consumes a large amount of processor resources to perform the bandwidth calculation, it affects the operation of other programs processed by the CPU. In addition, the CPU is often unable to allocate one processor core exclusively for bandwidth calculation. Furthermore, the CPU needs to read an external memory (e.g., dynamic random access memory (DRAM)) to obtain information required for bandwidth calculation (particularly, information reported by the ONU). However, the access latency of the external memory (e.g., DRAM) is long, causing the bandwidth calculation to take a longer processing time to complete.

### SUMMARY OF THE INVENTION

One of the objectives of the claimed invention is to provide an optical line terminal that uses a network processing unit to perform dynamic bandwidth allocation and a related dynamic bandwidth allocation method.

According to a first aspect of the present invention, an exemplary optical line terminal (OLT) is disclosed. The exemplary OLT includes a central processing unit (CPU) and a network processing unit (NPU). The NPU is configured to perform dynamic bandwidth allocation (DBA), wherein the DBA refers to frame contents transmitted by at least one transmission container within an upstream frame, to determine bandwidth allocated to the at least one transmission container.

According to a second aspect of the present invention, an exemplary dynamic bandwidth allocation (DBA) method is disclosed. The exemplary DBA method includes: using a network processing unit (NPU) of an optical line terminal (OLT) to perform DBA, wherein the OLT further comprises a central processing unit (CPU); and while the DBA is being executed, referring to frame contents transmitted by at least one transmission container within an upstream frame, to determine bandwidth allocated to the at least one transmission container.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an optical line terminal according to an embodiment of the present invention.

FIG. 2 is a flowchart illustrating a method of using a network processing unit to perform dynamic bandwidth allocation according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

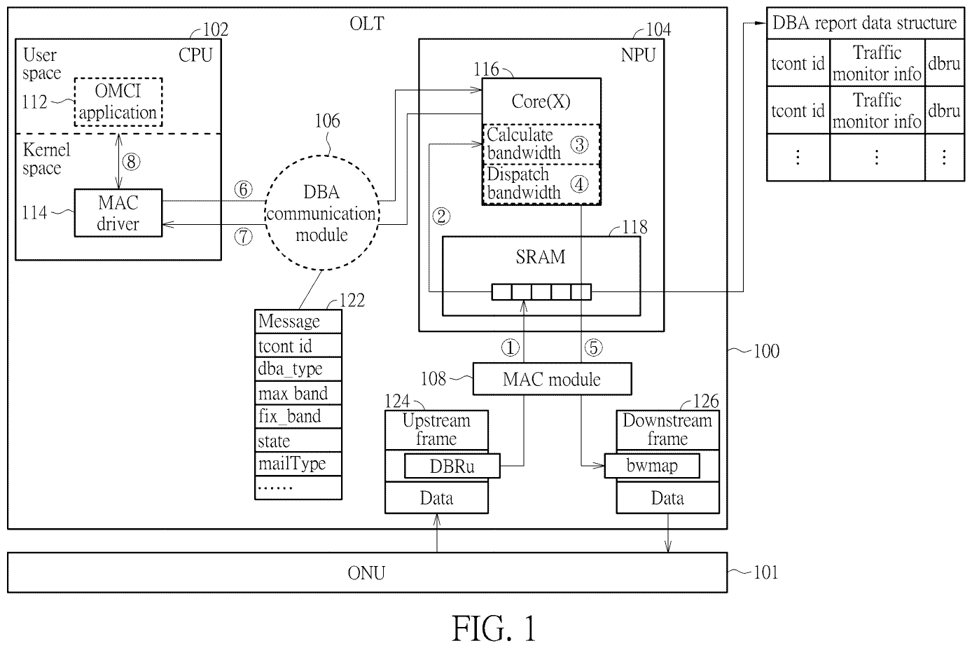

FIG. 1 is a diagram illustrating an optical line terminal (OLT) according to an embodiment of the present invention. For example, the OLT 100 may be an OLT that supports fiber to the room (FTTR) technology. By deploying the optical fiber to each room, the OLT may be connected to one ONU in each room via the optical fiber, and each ONU may be combined with Wi-Fi technology to ensure full-house network coverage, thereby meeting the high-speed Internet access needs of each family member. However, this is for illustrative purposes only, and is not meant to be a limitation of the present invention. In practice, any OLT using the hardware architecture proposed by the present invention to implement dynamic bandwidth allocation (DBA) falls within the scope of the present invention.

As shown in FIG. 1, the OLT 100 has a plurality of processors, including a central processing unit (CPU) 102 and a network processing unit (NPU) 104. The CPU 102 may be implemented by a general-purpose processor, and may load and execute a plurality of software modules, including an ONU Management and Control Interface (OMCI) application 112 and a Media Access Control (MAC) driver 114, wherein the OMCI application 112 runs in a user space and the MAC driver 114 runs in a kernel space.

The NPU 104 may be implemented by an application specific integrated circuit (ASIC) optimized for network applications. In this embodiment, the NPU 104 may have a DBA function. Hence, the DBA task of the CPU 102 may be offloaded to the NPU 104 to reduce the load of the CPU 102 and prevent the DBA from affecting operations of other programs processed by the CPU 102.

In addition, the NPU 104 may be a multi-core NPU having a plurality of processor cores. In this embodiment, a single processor core (labeled by “Core(X)”) 116 among the plurality of processor cores is assigned as a dedicated processor core for handling the DBA task, which can prevent DBA from affecting operations of other programs processed by other processor cores of the NPU 104.

While the NPU 104 (particularly, processor core 116 of NPU 104) is performing DBA, it determines the bandwidth allocated to at least one transmission container (tcont) according to frame contents transmitted by the at least one transmission container (e.g., the transmission container used by the ONU 101 shown in FIG. 1) within an upstream frame 124. For example, the frame contents of the upstream frame 124 include valid data transmitted by each transmission container, a valid data ratio (i.e., a ratio of valid data to the bandwidth allocated to the transmission container), and/or a dynamic bandwidth reporting unit (DBRu) value.

The DBA scheme proposed by the present invention is based on a multi-processor architecture having the CPU 102 and the NPU 104. The main objective is to offload the computing function from the CPU 102 to the NPU 104, leaving only the set function and the query function on the CPU 102. The DBA report receiving task, the bandwidth calculation task, and the bandwidth dispatch task (i.e., informing the ONU of the new bandwidth allocated to the transmission container) are handed over to the NPU 104.

As shown in FIG. 1, the NPU 104 further includes an internal memory (e.g., static random access memory (SRAM) 118) for storing information used by DBA, wherein the information is derived from the frame contents transmitted by the at least one transmission container (e.g., the transmission container used by the ONU 101 shown in FIG. 1). For example, the SRAM 118 stores DBA reports. As shown in FIG. 1, a DBA report data structure in the SRAM 118 includes a plurality of DBA reports that correspond to a plurality of transmission containers within the upstream frame 124, respectively. In addition, each DBA report has a transmission container identifier (labeled by “tcont id”), a traffic monitor information (labeled by “traffic monitor info”) and a DBRu value (labeled by “dbru”). Please note that only one ONU 101 is illustrated in FIG. 1 for brevity and simplicity. In practice, the OLT 100 may also be connected to a plurality of ONUs 101, where the plurality of ONUs 101 share the available upstream bandwidth of the OLT 100, and each ONU 101 may have one or more transmission containers. Compared to the external memory (e.g., DRAM), the internal memory (e.g., SRAM 118) has a faster access speed due to its lower access latency. Therefore, the NPU 104 can speed up the processing speed of DBA through its internal memory (e.g., SRAM 118).

In addition, the CPU 102 only needs to retain the set function and the query function. In this embodiment, the CPU 102 can set the DBA to be executed by the NPU 104 (e.g., the configuration of the transmission container, including whether the transmission container requires bandwidth, the bandwidth type, the bandwidth range, etc.) and can query the operating status of the DBA (e.g., the bandwidth allocated to the transmission container and the DBRu value reported by the ONU) through a DBA communication handler (e.g., a DBA communication module 106 shown in FIG. 1) of the NPU 104. The NPU 104 may have an interrupt handler. For example, the processor core 116 of the NPU 104 may register a DBA communication interrupt request (IRQ) and an interrupt handling function to be evoked by the DBA communication IRQ. When the CPU 102 wants to execute the set function, the CPU 102 can trigger the interrupt handler (which includes the DBA communication IRQ and the interrupt handling function of the processor core 116) to read a configuration of DBA that is set by the CPU 102 (e.g., the configuration of the transmission container, including whether the transmission container requires bandwidth, the bandwidth type, the bandwidth range, etc.). In addition, a flag which is used to indicate whether the configuration of DBA has been updated will be set to “1”. When the CPU 102 wants to execute the query function, the CPU 102 can trigger the interrupt handler (which includes the DBA communication IRQ and the interrupt handling function of the processor core 116) to report information of DBA (e.g., the bandwidth allocated to the transmission container and the DBRu value reported by the ONU) to the CPU 102. In this embodiment, a hardware timer and an interrupt handler used by DBA are registered to the same processor core 116, and are not shared with other modules for avoiding interference between them.

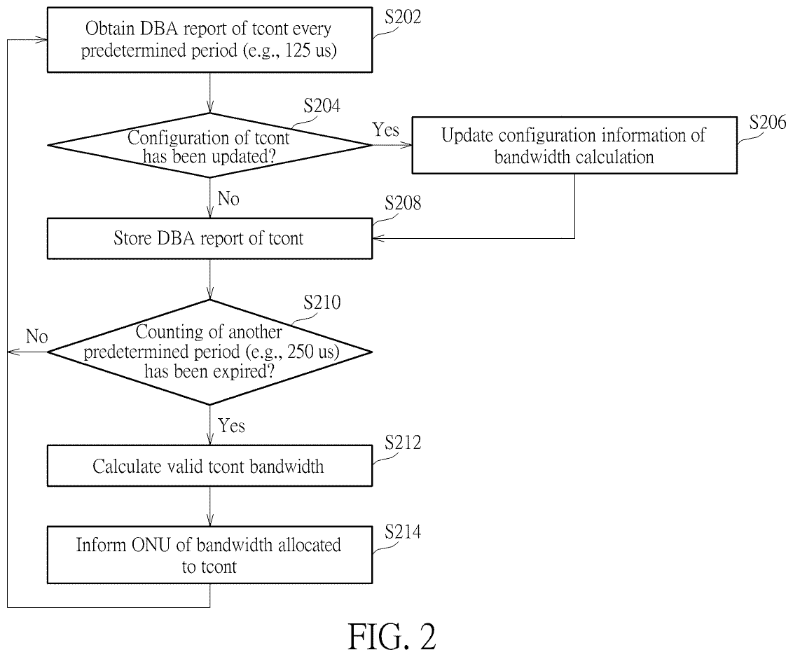

As mentioned above, the DBA report receiving task, the bandwidth calculation task and the bandwidth dispatch task are all handled by the NPU 104. Please refer to FIG. 2 in conjunction with FIG. 1. FIG. 2 is a flowchart illustrating a method of using the NPU 104 to perform DBA according to an embodiment of the present invention. If the result is substantially the same, the steps are not required to be executed in the exact order shown in FIG. 2. The processor core 116 sets a hardware timer. After a DBA flow starts, the processor core 116 activates counting of the hardware timer to control DBA operations. In other words, the DBA is executed periodically.

In step S202, a timer processing function executed by the processor core 116 obtains a DBA report of a transmission container (i.e., a DBA report of each valid transmission container within an upstream frame) every predetermined period (e.g., a frame duration 125 us of the upstream frame).

In step S204, the processor core 116 checks whether the CPU 102 executes the set function to update the original transmission container configuration (e.g., whether the transmission container requires bandwidth, the bandwidth type, the bandwidth range, etc.). If the transmission container configuration has been updated, the processor core 116 of the NPU 104 will update the configuration information of the bandwidth calculation accordingly (step S206), and then the flow proceeds to step S208. If step S204 judges that the transmission container configuration is not updated, the flow proceeds to step S208 directly. In step S208, the processor core 116 stores the acquired DBA report of the transmission container (i.e., the DBA report of each valid transmission container within the upstream frame) into the SRAM 118, where the acquired DBA report is stored using the DBA report data structure as shown in FIG. 1.

Specifically, the ONU 101 uses a dynamic bandwidth report unit (labeled by “DBRu”) to report the status of the to-be-transmitted data stored in its own buffer to the OLT 100. For example, the buffer of the ONU 101 is divided into a plurality of storage blocks according to a fixed block size. Therefore, the number of storage blocks in the buffer that store the to-be-transmitted data may be converted into a DBRu value (i.e., a value reported by DBRu) and then sent to the OLT 100 via the transmission container (whose currently allocated bandwidth is determined by a previous DBA operation) within the upstream frame 124. After the MAC module 108 receives the upstream frame 124, it parses the frame contents (which include the DBRu value and the amount of transmitted valid data that are reported by the ONU 101 through the transmission container) included in the upstream frame 124 to generate a DBA report of the transmission container that the OLT 100 will use when performing DBA. The processor core 116 stores the DBA report of the transport container extracted by the MAC module 108 into the SRAM 118 (as indicated by the circled number “1” in FIG. 1).

In addition, as indicated by the circled number “8” in FIG. 1, the upper-layer OMCI application 112 can evoke the MAC driver 114 to configure the DBA to be executed by the NPU 104 (e.g., the configuration of the transmission container, including whether the transmission container requires bandwidth, the bandwidth type, the bandwidth range, etc.), or to query the operating status of the DBA (e.g., the bandwidth allocated to the transmission container and the DBRu value reported by the ONU). Therefore, the CPU 102 can execute the set function (as indicated by the circled number “6” in FIG. 1) or the query function (as indicated by the circled number “7” in FIG. 1) by triggering an interrupt handler (which includes the DBA communication IRQ and the interrupt handling function of the processor core 116). In addition, the processor core 116 can also receive and process a set request or a query request of the CPU 102 through a DBA message handler. Therefore, the message 122 transmitted between the processor core 116 and the CPU 102 may include the configuration information that the CPU 102 wants to provide to the processor core 116, or the report information that the processor core 116 wants to provide to the CPU 102.

In step S210, the timer processing function executed by the processor core 116 checks whether the counting of another predetermined period (e.g., 250 us) has expired. If the counting of another predetermined period (e.g., 250 us) does not expire yet, the flow returns to step S202. In other words, in this embodiment, the DBA operation will perform bandwidth calculation of a transmission container once (step S212) after obtaining two DBA reports of transmission containers (i.e., DBA reports of valid transmission containers within two consecutive upstream frames). In this embodiment, the processor core 116 first reads the information required for subsequent bandwidth calculation (particularly, the DBA report of each transmission container) from the SRAM 118 (as indicated by the circled number “2” in FIG. 1), and then calculates the bandwidth by using two methods, including status reporting and traffic monitoring, through a compute band process (as indicated by the circled number “3” in FIG. 1). For example, the bandwidth to be allocated to the transmission container can be calculated by jointly considering the DBRu value of the transmission container and the valid data ratio of the transmission container. However, this is for illustrative purposes only, and is not meant to be a limitation of the present invention. Since the present invention is focused on the architecture for implementing DBA (i.e., offloading a DBA task of a CPU to an NPU) rather than the algorithm for calculating the bandwidth to be allocated, other algorithms for calculating the bandwidth to be allocated may also be adopted by the processor core 116. In other words, any OLT using the architecture for implementing DBA as proposed by the present invention (i.e., offloading a DBA task of a CPU to an NPU) falls within the scope of the present invention.

In step S214, the processor core 116 controls transmission of a downstream frame 126. The downstream frame 126 is sent to each ONU (e.g., ONU 101) in a broadcast manner. In addition, a bandwidth map field bwmap in the downstream frame 126 carries information of the bandwidth allocated to each transmission container. In this embodiment, the processor core 116 organizes the calculated bandwidth through a config band process, and divides it into multiple bursts according to specification requirements. If the forward error correction (FEC) is enabled in the ONU, the bandwidth needs to be adjusted to meet the FEC requirements (as indicated by the circled number “4” in FIG. 1). Next, the MAC module 108 fills the bandwidth allocation information (e.g., start_time and stop_time of each transmission container) into the bandwidth mapping field bwmap included in the downstream frame 126, and completes the task of dispatching the allocated bandwidth through broadcast of the downstream frame 126 (as indicated by the circled number “5” in FIG. 1). Each transmission container indicates the start time and the end time of data transmission through two fields start_time and stop_time set by the OLT 100. Specifically, the settings of start_time and stop_time are determined based on the bandwidth allocated to the transmission container.

In summary, the present invention proposes a DBA solution that is based on a CPU and an NPU, and has the following advantages. The processor core on the NPU that implements the DBA function is independent of other processor cores, and uses the internal memory (e.g., SRAM) of the NPU to store calculation data, which can improve the processing efficiency of bandwidth allocation. In addition, the bandwidth calculation operation and the set/query operation are deployed on the NPU and the CPU, respectively, thereby avoiding mutual interference between the bandwidth calculation operation and the set/query operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical line terminal (OLT) comprising:
a central processing unit (CPU); and
a network processing unit (NPU), configured to perform dynamic bandwidth allocation (DBA), wherein the DBA refers to frame contents transmitted by at least one transmission container within an upstream frame, to determine bandwidth allocated to the at least one transmission container.

2. The OLT of claim 1, wherein the NPU comprises a plurality of processor cores, and the DBA is executed on only a single processor core included in the plurality of processor cores.

3. The OLT of claim 1, wherein the NPU comprises:
an internal memory, configured to store information used by the DBA, wherein the information is derived from the frame contents transmitted by the at least one transmission container.

4. The OLT of claim 1, wherein the NPU has an interrupt handler, and the CPU is configured to trigger the interrupt handler to read a configuration of the DBA that is set by the CPU.

5. The OLT of claim 4, wherein the DBA is executed based on a hardware timer, the NPU comprises a plurality of processor cores, and the hardware timer and the interrupt handler are registered to a same processor core included in the plurality of processor cores.

6. The OLT of claim 1, wherein the NPU has an interrupt handler, and the CPU is configured to trigger the interrupt handler to report information of the DBA to the CPU.

7. The OLT of claim 6, wherein the DBA is executed based on a hardware timer, the NPU comprises a plurality of processor cores, and the hardware timer and the interrupt handler are registered to a same processor core included in the plurality of processor cores.

8. The OLT of claim 1, wherein the NPU is further configured to control transmission of a downstream frame, and the downstream frame carries information of the bandwidth allocated to the at least one transmission container.

9. A dynamic bandwidth allocation (DBA) method comprising:
using a network processing unit (NPU) of an optical line terminal (OLT) to perform DBA, wherein the OLT further comprises a central processing unit (CPU); and
while the DBA is being executed, referring to frame contents transmitted by at least one transmission container within an upstream frame, to determine bandwidth allocated to the at least one transmission container.

10. The DBA method of claim 9, wherein the NPU comprises a plurality of processor cores, and the DBA is executed on only a single processor core included in the plurality of processor cores.

11. The DBA method of claim 9, further comprising:
storing the frame contents transmitted by the at least one transmission container and used by the DBA into an internal memory of the NPU.

12. The DBA method of claim 9, wherein the NPU has an interrupt
handler, and the DBA method further comprises:
triggering the interrupt handler to read a configuration of the DBA that is set by the CPU.

13. The DBA method of claim 12, wherein the DBA is executed based on a hardware timer, the NPU comprises a plurality of processor cores, and the hardware timer and the interrupt handler are registered to a same processor core included in the plurality of processor cores.

14. The DBA method of claim 9, wherein the NPU has an interrupt
handler, and the DBA method further comprises:
triggering the interrupt handler to report information of the DBA to the CPU.

15. The DBA method of claim 14, wherein the DBA is executed based on a hardware timer, the NPU comprises a plurality of processor cores, and the hardware timer and the interrupt handler are registered to a same processor core included in the plurality of processor cores.

16. The DBA method of claim 9, further comprising:
using the NPU to control transmission of a downstream frame;
wherein the downstream frame carries information of the bandwidth allocated to the at least one transmission container.
